(19) United States
(12) Patent Application Publication
(10) Pub. No.: US 2006/0006076 A1
(43) Pub. Date: Jan. 12, 2006

(54) Moisture chamber for storage containers

(76) Inventor: Denise Rhea Retzner, Fishers, IN (US)

Correspondence Address: Denise R. Retzner, 12284 Silverado Drive, Fishers, IN, 46038, US

(21) Appl. No.: 10/884,582

(22) Filed: Jul. 6, 2004

(51) Int. Cl. B65D 81/24; A21D 10/02

(52) U.S. Cl. 206/205; 426/118; 426/124

(57) ABSTRACT

A moisture chamber is disclosed which is a receptacle in any storage container or bag comprising of an entry to the chamber separate or the same as the entry into the container itself but allowing a moisture source to be stored within the storage container and kept separate from food within the container while still allowing the free exchange of air between a moisture source and the food. Additionally, a self-contained moisture chamber is disclosed which is a self-contained receptacle into which can be place a moisture source and then placed into an existing container to allow the moisture source to be placed within the storage container and kept separate from food within the container while still allowing the free exchange of air between the moisture source and the food.

### BRIEF DESCRIPTION OF THE DRAWINGS

FIG. 1 is a front perspective view of a hard plastic storage container containing the moisture chamber in accordance with one embodiment of the present invention specifically designed to be incorporated into such a container.

FIG. 2 is a rear perspective view of FIG. 1.

FIG. 3 is an interior perspective view of the lid of the container of FIG. 1 containing the moisture chamber. This perspective shows the incorporated moisture chamber as viewed from the perspective of looking up into the lid from the bottom of the container.

FIG. 4 is an interior and exterior perspective view of an opened container of FIGS. 1 through 3 showing the incorporated moisture chamber within the lid of the container.

FIG. 5 is a front perspective view of a soft plastic storage container (a plastic bag), containing a moisture chamber, according to a second embodiment of the current invention.

FIG. 6 is an interior and downward perspective view of FIG. 5, viewing the container from the top and showing the approximate attachment point of the moisture chamber to the container.

FIG. 7 contains several perspective views of a third embodiment of the current invention, a self-contained moisture chamber to be used in storage containers not already fitted with an installed chamber as shown in FIGS. 1 through 6 above.

### DETAILED DESCRIPTION OF EMBODIMENTS OF THE INVENTION

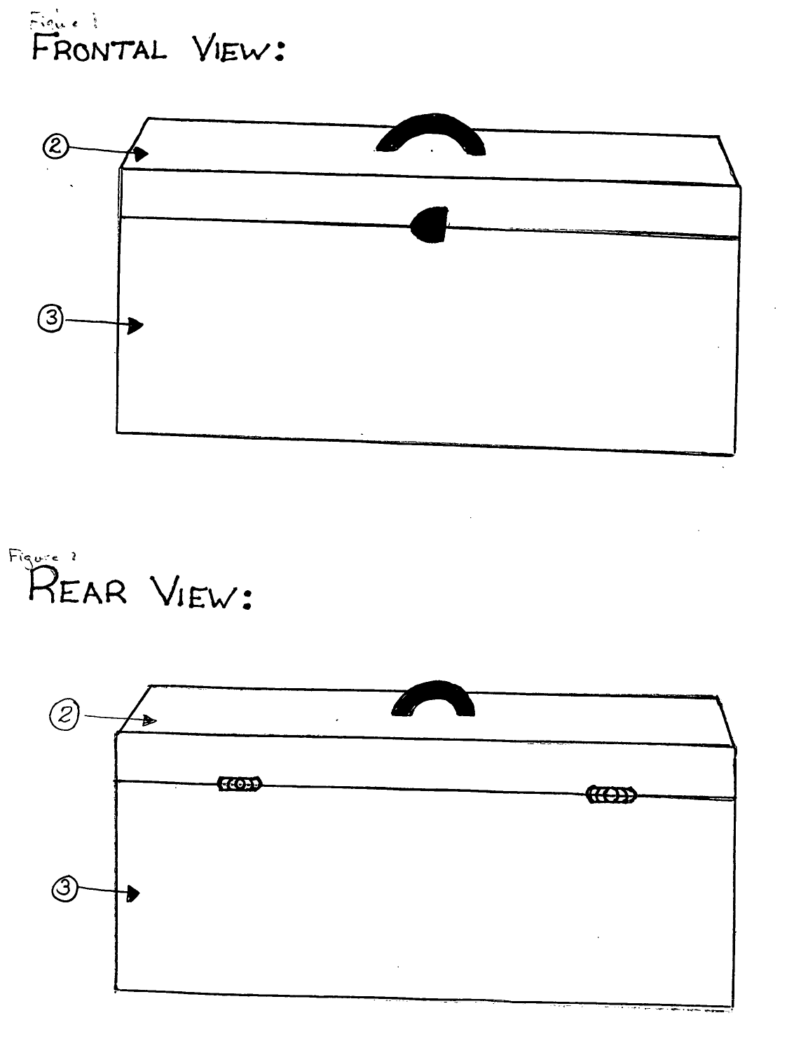

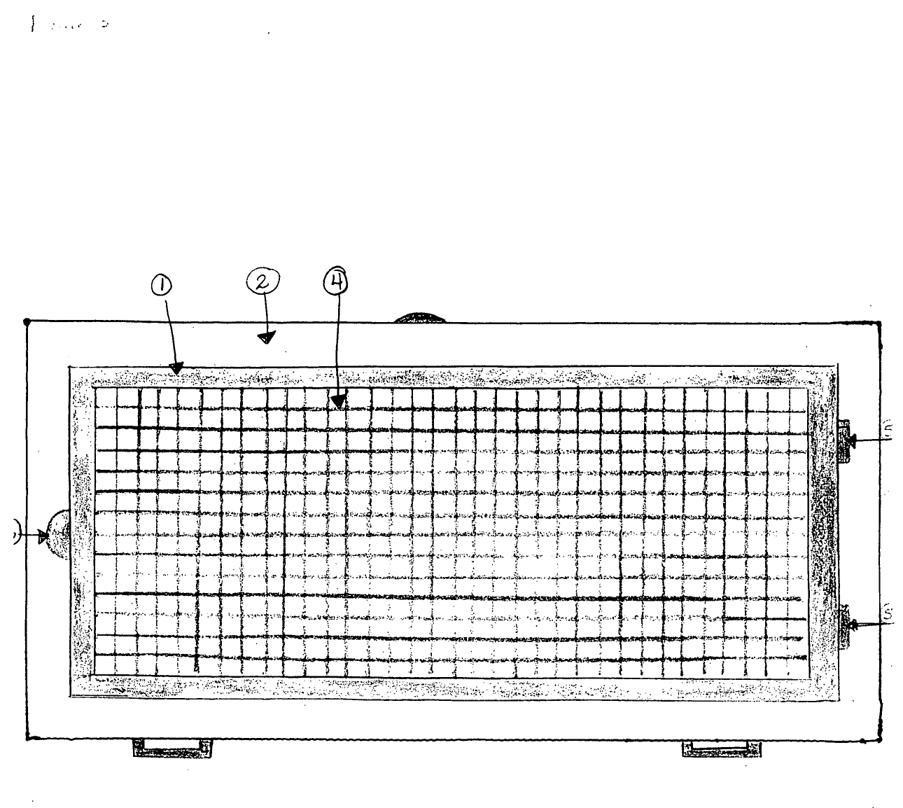

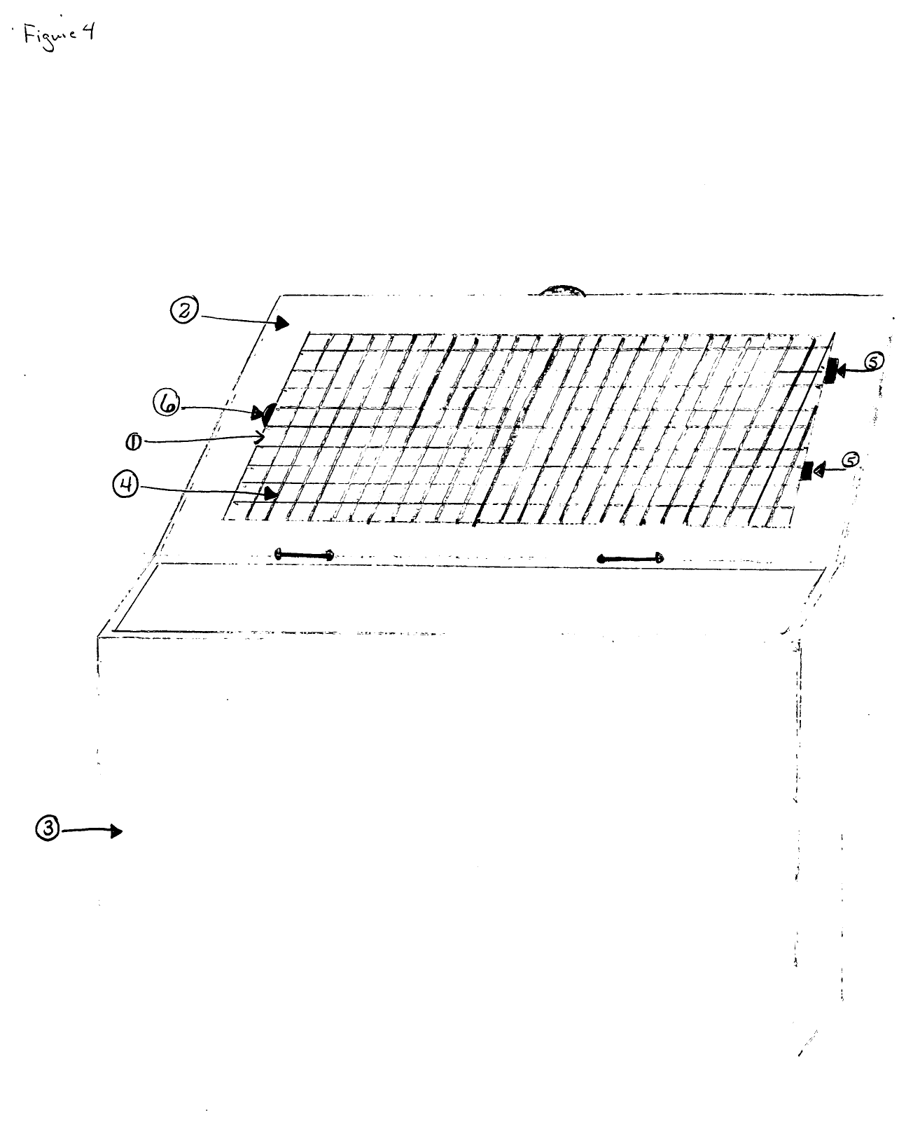

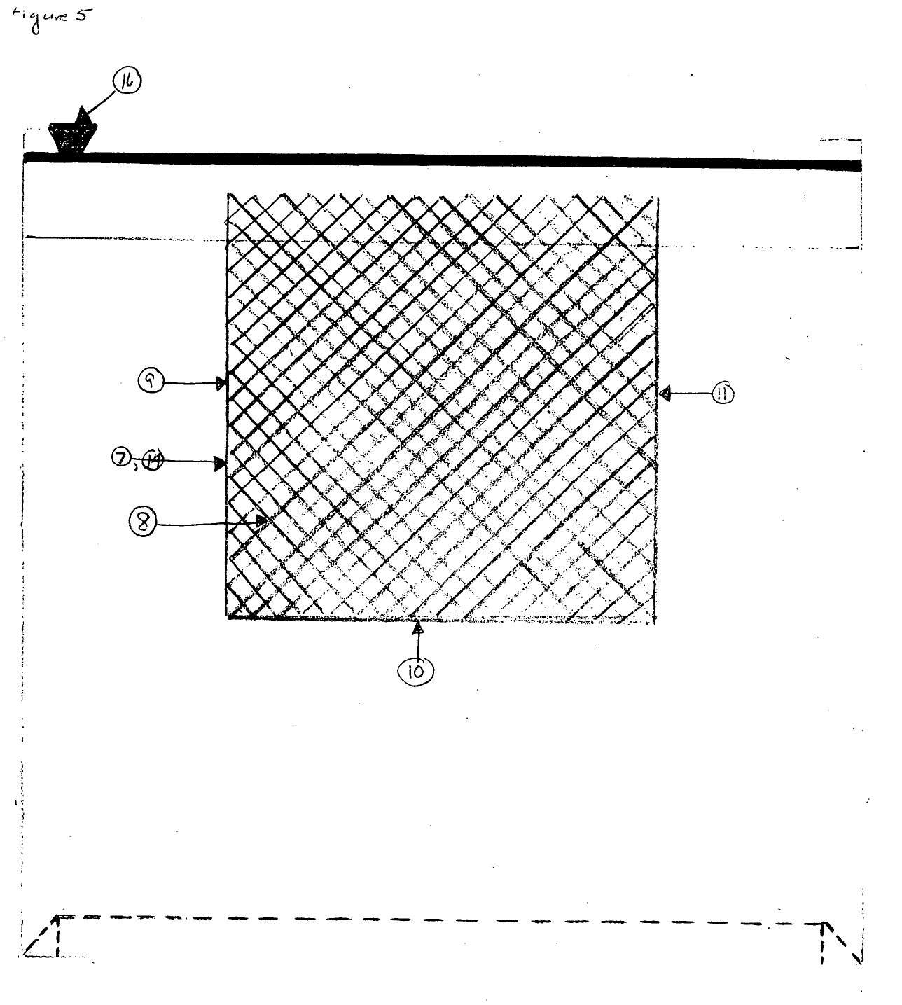

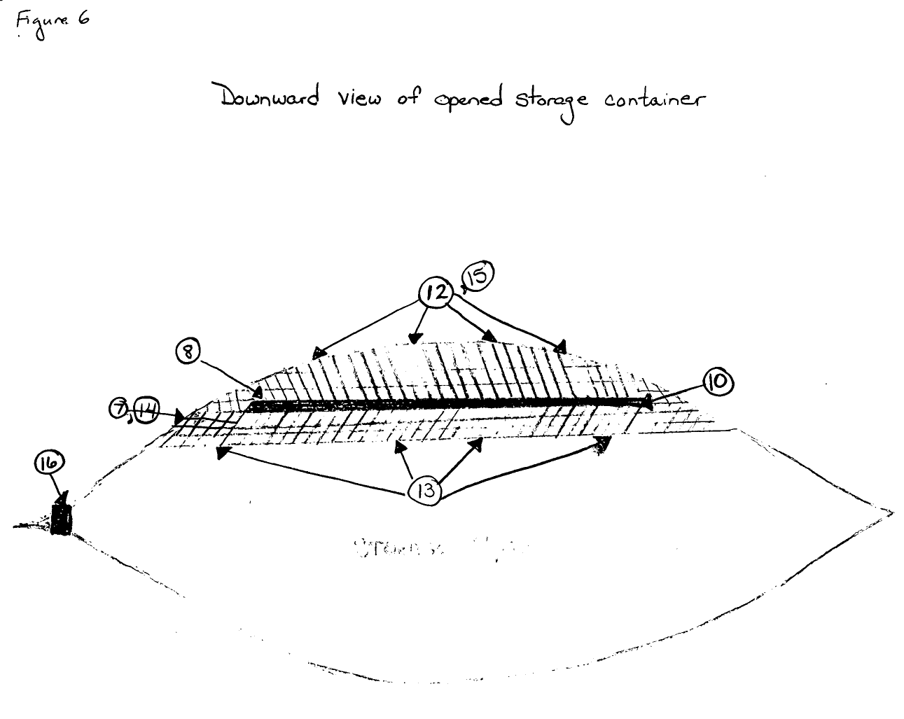

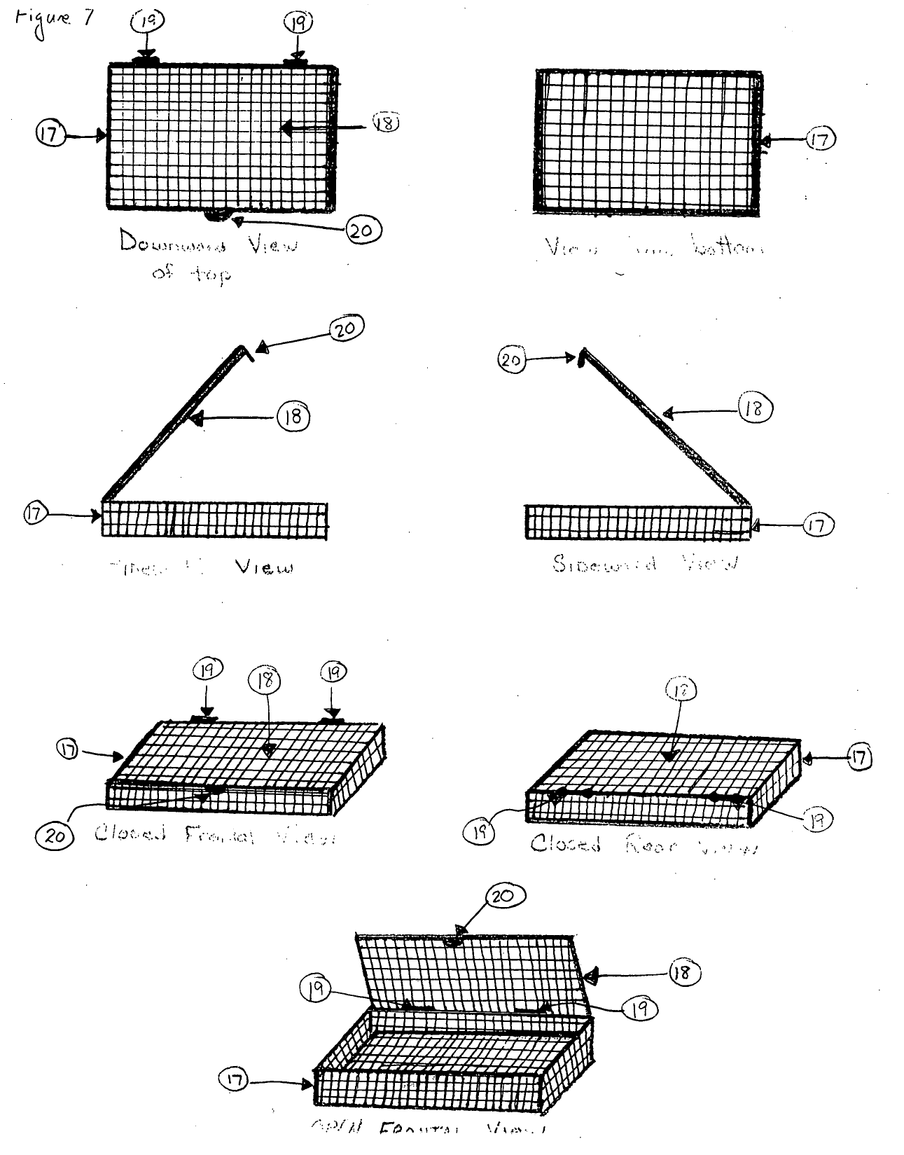

FIGS. 1 through 7 illustrate three embodiments of a moisture chamber in accordance with the present invention. The moisture chamber may be incorporated into hard plastic storage containers (as shown in FIGS. 1 through 4), soft plastic storage bags (as shown in FIGS. 5 and 6), or may be a self-contained unit for placing into already existing storage containers that do not have a moisture chamber incorporated as in the first two embodiments.

In any of the embodiments, the moisture chamber contains a moisture source, the moisture from which will be absorbed into food, usually baked goods, contained in the storage container, aiding in the premature drying out of the food and allowing the food to stay fresher and not stale.

In all three embodiments, the moisture source is separated from the baked goods by the grated sides of the moisture chamber, allowing for the free exchange of air between the moisture chamber and the food while keeping the moisture source separated from the food so as to not apply direct moisture to them and wetting the food.

Moisture Chamber in Hard Plastic Storage Containers: As shown in FIGS. 1 through 4, in the first embodiment, the moisture chamber 1 is contained entirely within the lid 2 of the hard plastic storage container 3 and consists of a hard plastic, non-stick grid 4 mounted on one end by two (swivel) hinges 5 and a closure clasp 6 on the opposite end. In variations of the first embodiment, the moisture chamber is a receptacle within the lid itself having a separate lid within the lid to allow opening from the outside of the container to replace the moisture source as needed. In yet other variations of the first embodiment, the moisture chamber can be contained within the container sides.

Suspended Moisture Pouch in Soft Plastic Storage Bags: In the second embodiment, shown in FIGS. 5 and 6, the moisture chamber pouch 7 consists of non-stick, pliable plastic netting 8, closed on three sides 9 10 11 and suspended from the upper, anterior middle portion of the plastic storage bag 12. The upper, interior portion of the suspended pouch 13 would be left unattached to the plastic storage bag to allow for insertion and removal of the moisture source. The anterior and exterior portion of the suspended pouch 14 is permanently mounted to the upper, anterior portion of the plastic storage bag 15 just below the closure device of the storage bag 16. Variations of the second embodiment include storage bags of different sizes with moisture pouches of different sizes.

Self-Contained Moisture Chambers: Several different perspective views of the third embodiment are shown in FIG. 7. The third embodiment is a self-contained moisture chamber consists of a non-stick, hard plastic cage, or box 17 of a hard plastic, non-stick grid material with a top lid 18 mounted on one end of the top of the cage by two (swivel) hinges 19 and a closure clasp 20 on the opposite end. The moisture chamber can then be placed into various storage containers. Variations of the third embodiment include self-contained moisture chambers of different shapes and sizes.

While specific embodiments of the invention have been shown and described herein for purposes of illustration, the protection offered by any patent which may issue upon this application is not strictly limited to the disclosed embodiments but rather extends to all storage containers containing a separate chamber to be used as a moisture chamber which would fall fairly within a scope of the claims which are appended hereto as well as any self-contained unit to be used as a moisture chamber in already existing storage containers.

What is claimed is:

1. A moisture chamber for storage containers or bags which separates a moisture source from food stored in the storage containers or bags, allowing for free air flow between the moisture source and the food to allow moisture to be drawn from the moisture source and reabsorbed into staling or hardened food without allowing the moisture source to come into direct with the food.
